(19) United States
(12) Patent Application Publication
(10) Pub. No.: US 2018/0017703 A1
(43) Pub. Date: Jan. 18, 2018

(54) PARTIALLY RUGGEDIZED RADIATION DETECTION SYSTEM

(71) Applicant: HALLIBURTON ENERGY SERVICES, INC., Houston, TX (US)

(72) Inventors: Dongwon LEE, Kingwood, TX (US); Daniel Joshua STARK, Houston, TX (US); Weijun GUO, Houston, TX (US)

(73) Assignee: HALLIBURTON ENERGY SERVICES, INC., Houston, TX (US)

(21) Appl. No.: 15/126,633

(22) PCT Filed: Dec. 4, 2015
(86) PCT No.: PCT/US2015/063855

§ 371 Date: Sep. 16, 2016

(51) Int. Cl. G01V 5/04

(52) U.S. Cl. CPC G01V 5/04

(57) ABSTRACT

A radiation sensor is provided. The sensor includes a rugged scintillator, a photo-sensor, a bundle of one or more optical fibers having a first end connected to the rugged scintillator and a second end connected to the photo sensor, a power supply coupled with the photo-sensor, and a processor electronically coupled with the photo-sensor.

### FIELD

The present disclosure relates generally to wellbore logging operations. In particular, the subject matter herein generally relates a detection system to be used in downhole radiation logging.

### BACKGROUND

Well logging is used to determine the type of geologic formations within a borehole. Earth formations penetrated by a borehole can be determined visually, through an inspection of earth samples brought to the surface, or by taking measurements with an instrument lowered into the borehole. Well logging can be beneficial in several types of boreholes including, but not limited to, those drilled for oil and gas, minerals, groundwater, and geothermal exploration.

Several different types of logging exist including resistivity logging, which measures subsurface electric resistivity; porosity logging, which measures the fraction or percentage of pore volume in a certain volume of rock; and lithology logging, which measures the physical and chemical properties of the earth formation. Tools used in lithology logging typically are lowered by several kilometers into the hole, and therefore must be able to withstand the extremely high subterranean temperatures and pressures.

### BRIEF DESCRIPTION OF THE DRAWINGS

Implementations of the present technology will now be described, by way of example only, with reference to the attached figures, wherein:

FIG. 1A is a diagram illustrating an embodiment of a deployed, downhole radiation detection system for detecting subterranean conditions;

FIG. 1B is a diagram illustrating an embodiment of a downhole radiation detection system for detecting subterranean conditions while drilling;

FIG. 1C is a diagram illustrating an embodiment of a downhole radiation detection system;

FIG. 2 is a cross-sectional diagram of an embodiment of the bundle of cables taken across line I-I of FIG. 1A;

FIG. 3 is a diagram illustrating an embodiment of an optical fiber; and

FIG. 4 is a flow diagram of a radiation detection process using the downhole radiation detector according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

In the above description, with respect to a wellbore, reference to up or down is made for purposes of description with “up,” “upper,” “upward,” or “uphole” meaning toward the surface of the wellbore and with “down,” “lower,” “downward,” or “downhole” meaning toward the terminal end of the well, regardless of the wellbore orientation. “Above ground” or “on the surface” refers to a point outside or above the wellbore.

Several definitions that apply throughout the above disclosure will now be presented. The term “coupled” is defined as connected, whether directly or indirectly through intervening components, and is not necessarily limited to physical connections. The connection can be such that the objects are permanently connected or releasably connected. The terms “comprising,” “including” and “having” are used interchangeably in this disclosure. The terms “comprising,” “including” and “having” mean to include, but not necessarily be limited to the things so described.

Disclosed herein is a partially ruggedized downhole radiation sensor for use in a wellbore. The downhole radiation sensor as disclosed herein includes a ruggedized downhole detecting component which may include a ruggedized radiation detector and a bundle of one or more optical fibers which can withstand the high temperatures and pressures of a downhole environment.

The downhole radiation sensor also has a surface component which includes an optical converter. The bundle of one or more optical fibers can be of sufficient length to connect the rugged radiation detector disposed downhole to the optical converter provided on the surface. The optical converter can additionally be coupled with a power supply and a processor on the surface.

As a result of placing the optical sensor on the surface rather than downhole, the optic sensor need not be ruggedized or modified to withstand a downhole environment. As a consequence, the optical sensor's life and ease of use may be enhanced. Furthermore, as opposed to downhole sensors, an optical sensor on the surface can be cooled while in use, which can provide an increased signal-to-noise ratio.

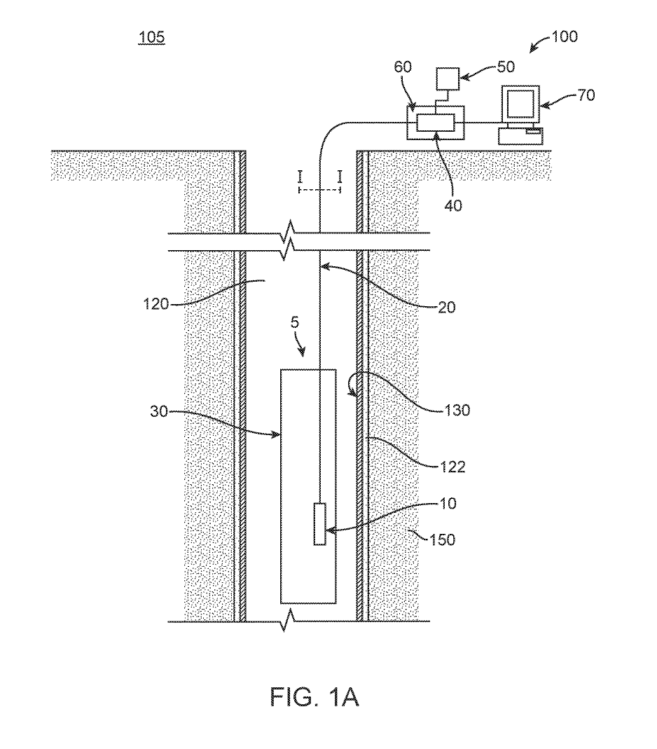

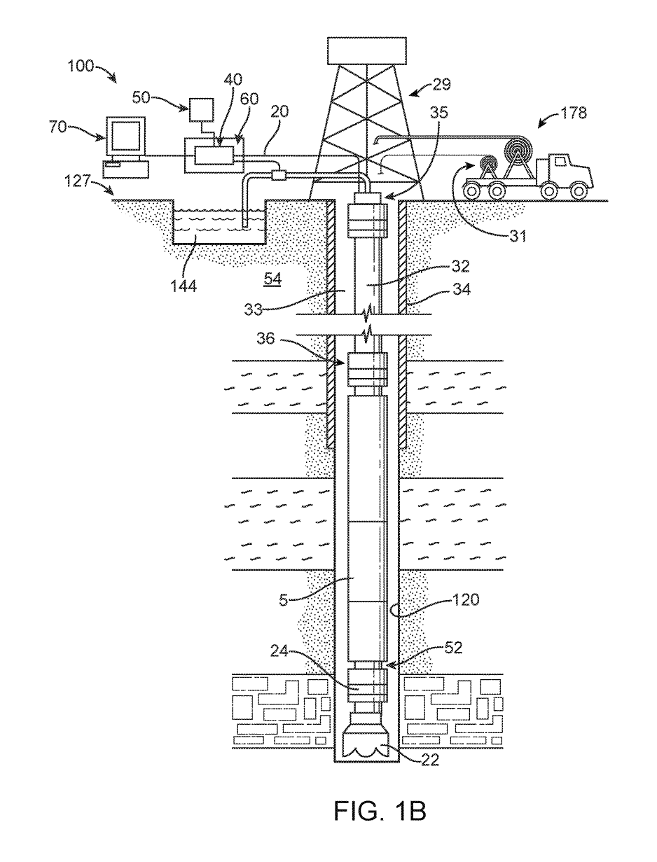

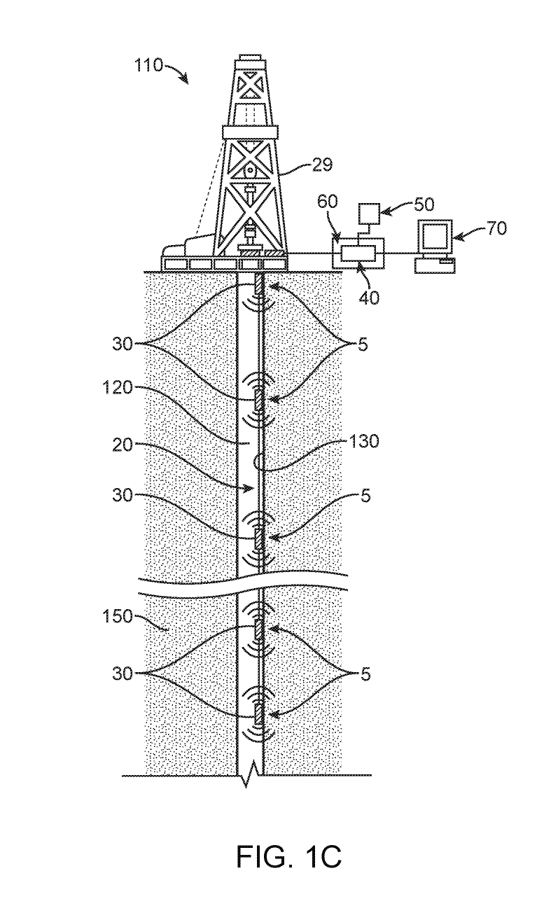

Referring to FIG. 1A, a wellbore 120 is provided through an earth formation 150 and has a casing 130 lining the wellbore 120, the casing 130 is held into place by cement 122. It should be noted that while FIG. 1A generally depicts a cased wellbore, those skilled in the art would readily recognize that the principles described herein are equally applicable to an uncased wellbore. The wellbore can be from 300 meters to over 20 kilometers in length.

The downhole radiation sensor system 105 can include the partially ruggedized downhole radiation sensor 100 deployed in wellbore 120. The partially ruggedized downhole radiation sensor 100 includes a ruggedized downhole component 5. The term “rugged” or “ruggedized” as used herein means a material, tool or device or other component that can withstand and regularly operate in conditions existing in a wellbore, such as temperatures in excess of 85 degrees Celsius, or in excess of 125 degrees Celsius, and at least able to withstand temperatures between 100-200 degrees Celsius, and/or pressures in excess of atmospheric pressure, and at least able to withstand pressures between 20-40 kpsi. Accordingly the temperature and pressure conditions in a wellbore as deep as 5 km, 10 km, 15 km or 20 km downhole can be withstood. Temperature resistant coatings and materials can be provided with any of the ruggedized downhole components to protect them in the downhole environment. Non-ruggedized products do not withstand or have not been modified to withstand the high temperatures and pressures of a wellbore environment, for example, they may only withstand temperatures at most up to about 75 degrees Celsius and pressures consistent with sea level.

The ruggedized downhole component 5 includes a ruggedized radiation detector, such as a scintillator 10 contained within a ruggedized housing 30 and a bundle 20 of optical fibers, where the scintillator 10 is coupled with the first end of a bundle 20 of optical fibers. The scintillator 10 and the connection between the scintillator 10 and the bundle 20 of optical fibers are disposed within the housing 30, such that the bundle 20 extends out of an upper portion of the housing 30 and to the surface. While the ruggedized radiation detector is generally referred to herein as including a scintillator it would be understood by those of skill in the art that the ruggedized radiation detector can be any optically clear media doped with scintillating materials. The scintillating material can include one or more of the following thallium doped sodium iodide (NaI(TI)), a lanthanum bromide (LaBr₃), thallium doped cesium iodide (CsI(TI)), sodium doped cesium iodide (CsI(Na)), bismuth germanate (BGO), or any suitable scintillation material. Commercial ruggedized scintillators and housings are available, for example, from Saint-Gobain. The housing 30 may be ruggedized with strengthening material, for example, titanium including titanium compounds such as titanium sapphire. The scintillator 10 is ruggedized by incorporation into the rugged housing and/or incorporated other ruggedized materials.

It should be noted that while the bundle of optical fibers is generally depicted as rugged, those skilled in the art would readily recognize that the principles described herein are equally applicable to a non-rugged bundle of optical fibers.

As seen in FIG. 1A, ruggedized downhole component 5 is deployed into the wellbore to detect radiation at various depths therein. The bundle 20 of optical fibers can be of sufficient length to reach the bottom of the wellbore, and thus can be a length of at least 300 meters to 20 kilometers or greater than 20 kilometers. Bundle 20 may be a single optical fiber component extending the entire needed length of the wellbore, multiple shorter portions linked together, or a disordered optical fiber.

The bundle 20 of optical fibers extends from the scintillator 10 within the wellbore 120 to the surface, where the second end of the bundle 20 of optical fibers is coupled with a surface component. Additional electrical cabling can also be provided for any other particular electronic components in ruggedized downhole component 5.

In operation, scintillator 10 will luminesce when excited by radiation in wellbore 120. Bundle 20 of optical fiber communicates the luminescence to the above ground equipment, which will process the received luminescence into useful data. The surface component connected to the bundle 20 of optical fibers can be, for example, an optical converter 40 that produces electrical signals in response to scintillation lights. Optical converter 40 can be a photo-sensor, but could also be or include carbon nanotubes, organic light emitting diodes (OLEDs), photomultiplier tubes (PMTs), photo-diodes, photoelectric sensors, phototransistors, photo IC sensors, spectrometers, quantum dot photodetectors, quantum photodiodes, or any other suitable device which produces electrical signals in response to exposure to electromagnetic radiation.

The optical converter 40 can be disposed within a housing 60 and powered by an outside power source, such as power supply 50. The housing 60 can include a cooling mechanism if the optical converter 40 is a type that needs to be cooled. The cooling mechanism can be a thermoelectric cooler, a fan, a cryogenic cooler, a combination thereof, or any other suitable cooling mechanism.

The output of optical converter 40 can be coupled with a processor 70 such that information detected by the downhole radiation sensor can be analyzed. The optical converter 40, power supply 50, housing 60 and processor 70 can be either stationary, for example, contained in a building, or mobile, for example, contained in a vehicle.

Optical converters 40 are typically extremely temperature sensitive and generate significant interference if exposed to subterranean conditions, and if deployed in wellbore 120 may require specialized cooling equipment, a rugged local power supply, and rugged electrical cabling to carry electrical signals to above ground monitoring equipment. By locating the optical converter 40 above-ground, non-ruggedized components can be used, and a dedicated rugged power supply and extended lengths of electrical cabling can be omitted. Commercial non-ruggedized optical converters are available from, at least, OSRAM Opto Semiconductors, ROHM Semiconductor, Vishay Semiconductors, Texas Instruments, Silicon Labs, and Omron Electronics.

Although FIG. 1A shows an exemplary environment relating to downhole radiation logging employing wireline operations, the present disclosure is equally well-suited for use in “logging while drilling” (LWD) operations, as shown in FIG. 1B. A wellbore 120 is shown that has been drilled into the earth 54 from the ground's surface 127 using a drill bit 22. The drill bit 22 is located at the bottom, distal end of the drill string 32 and the drill bit 22 and drill string 32 are being advanced into the earth 54 by the drilling rig 29. For illustrative purposes, the top portion of the wellbore 120 includes a casing 34 that is typically at least partially made up of cement and which defines and stabilizes the wellbore after being drilled. The drill bit 22 can be rotated via rotating the drill string, and/or a downhole motor near drill bit 22.

As shown in FIG. 1B, the drill string 32 supports several components along its length, including the ruggedized downhole component 5 of the partially ruggedized downhole radiation sensor described above. A sensor sub-unit 52 is shown for detecting conditions near the drill bit 22, conditions which can include such properties as formation fluid density, temperature and pressure, and azimuthal orientation of the drill bit 22 or string 32. Measurement while drilling (MWD) and LWD procedures are supported both structurally and communicatively, which can include radiation detection as discussed herein. The instance of directional drilling is illustrated in FIG. 1B. The lower end portion of the drill string 32 can include a drill collar proximate the drilling bit 22 and a drilling device such as a rotary steerable drilling device 24, or other drilling devices disclosed herein. The drill bit 22 may take the form of a roller cone bit or fixed cutter bit or any other type of bit known in the art. The sensor sub-unit 52 is located in or proximate to the rotary steerable drilling device 24 and advantageously detects the azimuthal orientation of the rotary steerable drilling device 24. Other sensor sub-units 35, 36 are shown within the cased portion of the well which can be enabled to sense nearby characteristics and conditions of the drill string, formation fluid, casing and surrounding formation.

Coiled tubing 178 and wireline 31 can be deployed as an independent service upon removal of the drill string 32 (shown for example in FIG. 1A). Drilling mud 144 may be circulated down through the drill string 32 and up the annulus 33 around the drill string 32 to cool the drill bit 22 and remove cuttings from the wellbore 120.

A surface component is shown that receives data from the ruggedized downhole component 5. A bundle 20 of optical fibers can be disposed within the drill string 32 to transmit information from the ruggedized downhole component 5 to the surface component. The surface component can include an optical converter 40, disposed within a housing 60 and powered by a power supply 50. The optical converter 40 can be coupled to a processor 70.

Alternatively, as shown in FIG. 1C, the partially ruggedized radiation system can be fixed downhole on a permanent or semi-permanent basis. The fixed downhole radiation system 110 can include a plurality of ruggedized downhole components 5 embedded in the casing 130 of the wellbore 120 or other tubular. In the alternative, each of the ruggedized downhole components 5 can be embedded in cement. Each of the ruggedized downhole components 5 can include a scintillator and ruggedized housing 30 and can be connected by a ruggedized bundle 20 of optical fibers. As described above, the ruggedized bundle 20 of optical fibers communicates the luminescence to the above ground equipment, which will process the received luminescence into useful data. The surface component can include an optical converter 40, disposed within a housing 60 and powered by a power supply 50. The optical converter 40 can be coupled to a processor 70. As a result of placing the optical converter above-ground, no electrical power source is needed downhole, allowing for continuous readings.

It should be noted that while FIGS. 1A-1C generally depict land-based operations, those skilled in the art would readily recognize that the principles described herein are equally applicable to operations that employ floating or sea-based platforms and rigs, without departing from the scope of the disclosure. Also, even though FIGS. 1A-1C depict a vertical wellbore, the present disclosure is equally well-suited for use in wellbores having other orientations including horizontal wellbores, slanted wellbores, multilateral wellbores or the like.

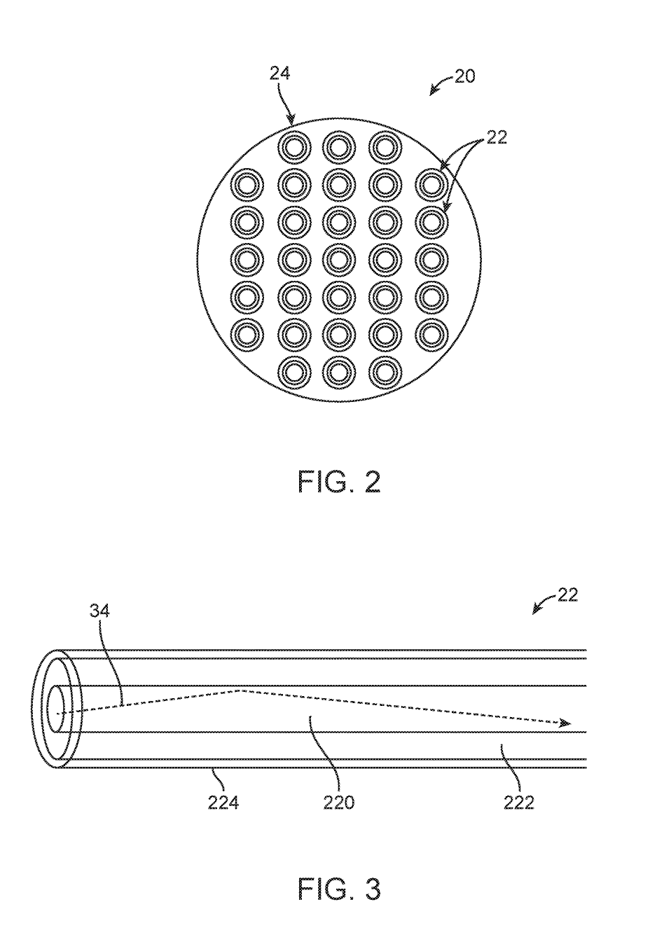

A cross sectional view of the bundle 20 is shown in FIG. 2. As shown, the bundle 20 can be made up of multiple individual optical fibers 22. The optical fibers 22 can be either single-mode fibers or multimode fibers. While FIG. 2 generally depicts a plurality of optical fibers 22 all of which have the same or a similar diameter, those skilled in the art would recognize that the bundle 20 could include a plurality of optical fibers 22 of varying diameters without departing from the scope of the disclosure. Varying the size of the core of the optical fibers 22 can increase the amount of information gathered with each reading.

A rugged coating 24 surrounds the bundle 20 of optical fibers 22 and protects them from increasing temperatures and pressures downhole. The coating 24 can be either organic or inorganic material. For example, the coating 24 material can be epoxy, epoxy phenolic, epoxy novolac, silicone, silicone-PFA, carbon, carbon composite, polyimide, multi-polymeric matrix, pressure-sensitive tape (PSA), acrylate, high-temperature acrylate, fluorogacrylate, silicone/acrylate, fluoropolymers, polyether ether ketone (PEEK), polybutylene terephthalate (PBT), polypropylene (PP), polyethylene (PE), polyamide (PA), low smoke zero halogen (LSZH), polyvinyl chloride (PVC), polyvinylidene fluoride (PVDF), Teflon, ceramics, aluminum cadmium, nickel aluminum bronze, nickel-plated aluminum, anodized aluminum, or any other suitable high temperature resistant coating material.

It should be noted that while FIG. 2 generally depicts the plurality of optical fibers 22 in a bundle 20, those skilled in the art would recognize that the optical fibers 22 could be disposed within a ribbon, interspersed with electrical wiring, or made from a single disordered optical fiber without departing from the scope of the disclosure. Also, while the bundle 20 is depicted as having a circular cross-section and set number of optical fibers, those skilled in the art would recognize that the bundle could be of any suitable geometric shape and have any number of optical fibers disposed therein.

FIG. 3 illustrates one example of an optical fiber 22 that can be used with any embodiment herein. The optical fiber 22 can include a core 220 and cladding 222. The optical fibers 22 can be made of silica, fluorozirconate glass, fluoroaluminate glass, phosphate glass, sapphire glass, chalcogenide glass, crystalline materials, plastic (such as polystyrene) or any other suitable material. For example, in FIG. 3, the core 220 and cladding 222 can be made of silica. Additionally, the optical fiber can include, for example, titanium, chromium, nano-rods, nano-stars, or microbeads. The optical fiber can also be doped, for example, using quantum dots, dyes, neodymium, ytterbium, erbium, thulium, praseodymium, holmium, or any other suitable ion. The optical fibers 22 used in conjunction with the downhole radiation sensor can also include a jacket 224, such that they are protected from the harsh environment downhole. The jacket can be made up of the same materials as coating 24 for ruggedizing.

The light 34 from the scintillator 10 (as shown in FIG. 1B) enters the optical fiber 22 and travels up to the optical converter 40. The amount of light 34 capable of entering the optical fiber 22 is determined by the size of the optical fiber core 220. A smaller optical fiber core 220 can only take in a small amount of light, but the light will not suffer a significant amount of transmission loss. A larger optical fiber core 220 can take in a significantly larger amount of light; however the light would be subject to a higher degree of transmission loss due to light scattering. The diameter of the core 220 can range from 1 micron to 65 microns.

In the alternative, the optical fibers 22 could be used as a radiation detector, for example, scintillating optical fibers. In the alternative, the housing 30 (as shown in FIG. 1B) can be coated with a reflective material such that the light produced by the scintillator 10 is enhanced before entering the optical fibers 22.

The connection between the scintillator 10 and the bundle 20 of optical fibers 22 can include, but is not limited to, a male/female connection, a Subscriber Connector (SC), a Straight Tip (ST) Connector, a Lucent Connector (LC), an E-2000 connection, or any other suitable optical fiber connector. The connection can further include an index matching medium, such that the light transmission between the two optical components is enhanced. The index matching medium can be, for example, an optical gel. The index matching medium is ruggedized for subterranean environment. Additional optical components, such as lenses, optical filters, reflectors, polarizers, and beam expanders, can be included.

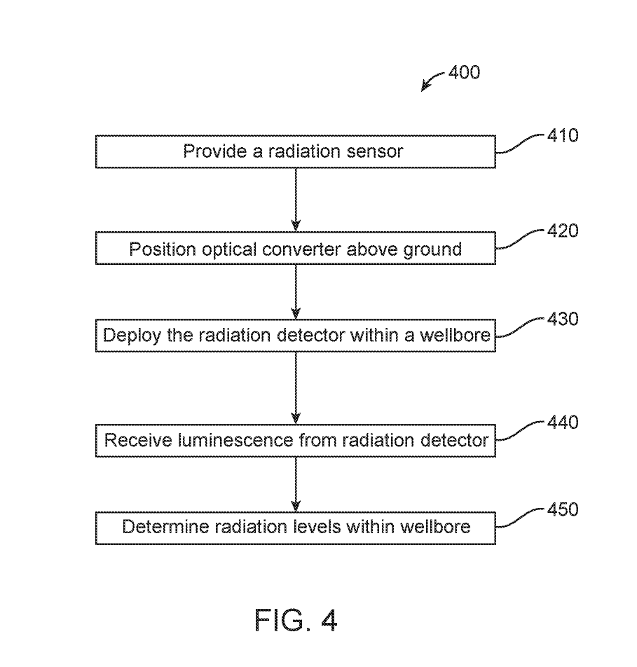

The process of detecting downhole radiation can follow the flow diagram 400 depicted in FIG. 4. For example, beginning at block 410, a ruggedized scintillator 10, a rugged bundle 20 of optical fibers 22, and an optical converter 40 are provided. The optical converter 40 is coupled with a power supply 50 and a processor 70. The scintillator 10 and a portion of the bundle 20 of optical fibers 22 are enclosed in a ruggedized housing 30, collectively referred to as ruggedized downhole component 5.

In block 420, the optical converter 40, the processor 70, and the power supply 50 are positioned and secured above-ground. In block 430, the ruggedized downhole component 5 is lowered into a wellbore 120. The bundle 20 of optical fibers 22 can be used as a structural conveyance to support the weight of the ruggedized downhole component 5. In the alternative, a separate conveyance can be included, for example, a wireline, work string production tubing, or any other suitable conveyance such that the bundle 20 of optical fibers 22 are not weight bearing or are partially weight bearing.

When the ruggedized downhole component 5 reaches a predetermined location within the wellbore 120, the scintillator 10 detects radiation present in the earth formation, as shown in block 440. Radiation levels can be detected by luminescence. This can be done, for example, using a scintillator.

In block 450, the radiation, or luminescence, detected by the scintillator 10 is transported via light through the bundle 20 of optical fibers 22 and analyzed by the optical converter 40. The optical converter 40 sends the information gathered downhole to the processor 70, which translates and displays the information.

The process can be repeated as frequently as necessary, at various depths within the wellbore to achieve a full understanding of the earth formation 150 surrounding the wellbore 120.

Numerous examples are provided herein to enhance understanding of the present disclosure. A specific set of statements are provided as follows.

Statement 1: A radiation sensor including a radiation detector; an optical converter; a bundle of one or more optical fibers having a first end coupled with the radiation detector and a second end coupled with the optical converter; a power supply coupled with the optical converter; and a processor electronically coupled with the optical converter.

Statement 2: An apparatus is disclosed according to Statement 1, wherein the bundle of one or more optical fibers has a length of at least 300 meters.

Statement 3: An apparatus is disclosed according to Statement 1 or Statement 2, wherein the optical converter is any of a photomultiplier tube (PMT), a photo-diode, a photoelectric sensor, a phototransistor, a photo IC sensor, a photoelectric sensor, a phototransistor, a carbon-nanotube, an organic light emitting diode (OLED), a spectrometer, a quantum dot photodetector, and a quantum photodiode.

Statement 4: An apparatus is disclosed according to Statements 1-3, wherein the radiation detector is rugged.

Statement 5: An apparatus is disclosed according to Statements 1-4, wherein the power supply is non-rugged.

Statement 6: An apparatus is disclosed according to Statements 1-5, further comprising a rugged index matching medium between the radiation detector and the bundle of one or more optical fibers.

Statement 7: An apparatus is disclosed according to Statements 1-6, further comprising one or more of a lens, an optical filter, a reflector, a polarizer, and a beam expander.

Statement 8: An apparatus is disclosed according to Statements 1-7, wherein each of the one or more optical fibers have varying diameters.

Statement 9: An apparatus is disclosed according to Statements 1-8, wherein each of the one or more optical fibers of the bundle has a layer of cladding.

Statement 10: An apparatus is disclosed according to Statements 1-9, wherein the bundle has a temperature resistant coating material.

Statement 11: An apparatus is disclosed according to Statements 1-10, wherein the one or more optical fibers of the bundle have one more layers of a temperature resistant coating material.

Statement 12: An apparatus is disclosed according to Statements 1-11, wherein the temperature resistant coating material is one of epoxy, epoxy phenolic, epoxy novolac, silicone, silicone-PFA, carbon, carbon composite, polyimide, multi-polymeric matrix, pressure-sensitive tape (PSA), acrylate, high-temperature acrylate, fluorogacrylate, silicone/acrylate, fluoropolymers, polyether ether ketone (PEEK), polybutylene terephthalate (PBT), polypropylene (PP), polyethylene (PE), polyamide (PA), low smoke zero halogen (LSZH), polyvinyl chloride (PVC), polyvinylidene fluoride (PVDF), Teflon, ceramics, aluminum cadmium, nickel aluminum bronze, nickel-plated aluminum, and anodized aluminum.

Statement 13: An apparatus is disclosed according to Statements 1-12, wherein the radiation detector is a scintillator.

Statement 14: An apparatus is disclosed according to Statements 1-13, wherein the scintillator is one of thallium doped sodium iodide (NaI(TI)), a lanthanum bromide (LaBr₃), thallium doped cesium iodide (CsI(TI)), sodium doped cesium iodide (CsI(Na)), and bismuth germanate (BGO).

Statement 15: An apparatus is disclosed according to Statements 1-14, wherein the radiation detector is contained within a rugged housing.

Statement 16: An apparatus is disclosed according to Statements 1-15, wherein the bundle of one or more optical fibers is rugged.

Statement 17: A method for downhole radiation detection including providing a radiation detector, deploying the radiation detector downhole within a wellbore; positioning an optical converter and a power supply above ground, wherein an optical fiber cable bundle couples the radiation detector with the optical converter; receiving luminescence from the radiation detector at the optical converter through at least the optical fiber cable; and determining from the optical converter levels of the radiation within the wellbore.

Statement 18: A method is disclosed according to Statement 17, wherein the optical fiber cable bundle has a length of at least 300 meters.

Statement 19: A method is disclosed according to Statement 17 or Statement 18, wherein providing the optical converter further comprises providing any of a photomultiplier tube (PMT), a photo-diode, a photoelectric sensor, a phototransistor, a photo IC sensor, a photoelectric sensor, a phototransistor, a carbon-nanotube, an organic light emitting diode (OLED), a spectrometer, a quantum dot photodetector, and a quantum photodiode.

Statement 20: A method is disclosed according to Statements 17-19, wherein the radiation detector is a rugged radiation detector.

Statement 21: A method is disclosed according to Statements 17-20, wherein the power supply is a non-rugged power supply.

Statement 22: A method is disclosed according to Statements 17-21, further comprising providing a rugged index matching medium between the radiation detector and the bundle of optical fibers.

Statement 23: A method is disclosed according to Statements 17-22, further comprising one or more of a lens, an optical filter, a reflector, a polarizer, and a beam expander.

Statement 24: A method is disclosed according to Statements 17-23, wherein providing the optical fiber cable bundle further comprises providing an optical fiber cable bundle having one or more optical fibers having varying diameters.

Statement 25: A method is disclosed according to Statements 17-24, wherein each of the one or more optical fibers of the bundle has a layer of cladding.

Statement 26: A method is disclosed according to Statements 17-25, wherein the radiation detector is a scintillator.

Statement 27: An apparatus is disclosed according to Statements 17-26, wherein the scintillator is one of thallium doped sodium iodide (NaI(TI)), a lanthanum bromide (LaBr₃), thallium doped cesium iodide (CsI(TI)), sodium doped cesium iodide (CsI(Na)), and bismuth germanate (BGO).

Statement 28: A method is disclosed according to Statements 17-27, further comprising encasing the radiation detector within a rugged housing.

Statement 29: A method is disclosed according to Statements 17-28, wherein the one or more optical fibers have one more layers of a temperature resistant coating material.

Statement 30: A method is disclosed according to Statements 17-29, wherein providing the optical fiber cable bundle further comprises providing the optical fiber cable bundle with a temperature resistant coating material.

Statement 31: A method is disclosed according to Statements 17-30, wherein the temperature resistant coating material is one of epoxy, epoxy phenolic, epoxy novolac, silicone, silicone-PFA, carbon, carbon composite, polyimide, multi-polymeric matrix, pressure-sensitive tape (PSA), acrylate, high-temperature acrylate, fluorogacrylate, silicone/acrylate, fluoropolymers, polyether ether ketone (PEEK), polybutylene terephthalate (PBT), polypropylene (PP), polyethylene (PE), polyamide (PA), low smoke zero halogen (LSZH), polyvinyl chloride (PVC), polyvinylidene fluoride (PVDF), Teflon, ceramics, aluminum cadmium, nickel aluminum bronze, nickel-plated aluminum, and anodized aluminum.

Statement 32: A method is disclosed according to Statements 17-30, wherein the optical fiber cable bundle is rugged.

Statement 33: A radiation sensor including a rugged scintillator; a non-rugged photo-sensor; a bundle of one or more optical fibers having a first end coupled with the rugged scintillator and a second end coupled with the non-rugged photo-sensor; a non-rugged power supply coupled with the optical converter; and a processor electronically coupled with the optical converter.

Statement 34: An apparatus is disclosed according to Statement 33, wherein the bundle of one or more optical fibers has a length of at least 300 meters.

Statement 35: An apparatus is disclosed according to Statement 33 or Statement 34, wherein the non-rugged photo-sensor is any of a photomultiplier tube (PMT), a photo-diode, a photoelectric sensor, a phototransistor, a photo IC sensor, a photoelectric sensor, a phototransistor, a carbon-nanotube, an organic light emitting diode (OLED), a spectrometer, a quantum dot photodetector, and a quantum photodiode.

Statement 36: An apparatus is disclosed according to Statements 33-35, further comprising rugged index matching medium between the rugged scintillator and the bundle of one or more optical fibers.

Statement 37: An apparatus is disclosed according to Statements 33-36, further comprising one or more of a lens, an optical filter, a reflector, a polarizer, and a beam expander.

Statement 38: An apparatus is disclosed according to Statements 33-37, wherein each of the one or more optical fibers have varying diameters.

Statement 39: An apparatus is disclosed according to Statements 33-38, wherein each of the one or more optical fibers of the bundle has a layer of cladding.

Statement 40: An apparatus is disclosed according to Statements 33-39, wherein the one or more optical fibers of the bundle have one more layers of a temperature resistant coating material.

Statement 41: An apparatus is disclosed according to Statements 33-40, wherein the bundle has a temperature resistant coating material.

Statement 42: An apparatus is disclosed according to Statements 33-40, wherein the temperature resistant coating material is one of epoxy, epoxy phenolic, epoxy novolac, silicone, silicone-PFA, carbon, carbon composite, polyimide, multi-polymeric matrix, pressure-sensitive tape (PSA), acrylate, high-temperature acrylate, fluorogacrylate, silicone/acrylate, fluoropolymers, polyether ether ketone (PEEK), polybutylene terephthalate (PBT), polypropylene (PP), polyethylene (PE), polyamide (PA), low smoke zero halogen (LSZH), polyvinyl chloride (PVC), polyvinylidene fluoride (PVDF), Teflon, ceramics, aluminum cadmium, nickel aluminum bronze, nickel-plated aluminum, and anodized aluminum.

Statement 43: An apparatus is disclosed according to Statements 33-42, wherein the scintillator is one of thallium doped sodium iodide (NaI(TI)), a lanthanum bromide (LaBr₃), thallium doped cesium iodide (CsI(TI)), sodium doped cesium iodide (CsI(Na)), and bismuth germanate (BGO).

Statement 44: An apparatus is disclosed according to Statements 33-43, wherein the rugged scintillator is contained within a rugged housing.

Statement 45: An apparatus is disclosed according to Statements 33-44, wherein the bundle of one or more optical fibers is rugged. Statement 46: A downhole radiation detection system including a surface component disposed on the surface including a an optical converter, a power supply coupled with the optical converter; a downhole component disposed in a wellbore including a detector; and one or more optical fibers having a first end coupled with the detector and a second end coupled with an optical converter.

Statement 47: A system is disclosed according to Statement 46, wherein the one or more optical fibers has a length of at least 300 meters.

Statement 48: A system is disclosed according to Statement 46 or Statement 47, wherein the optical converter is any of a photomultiplier tube (PMT), a photo-diode, a photoelectric sensor, a phototransistor, a photo IC sensor, a photoelectric sensor, a phototransistor, a carbon-nanotube, an organic light emitting diode (OLED), a spectrometer, a quantum dot photodetector, and a quantum photodiode.

Statement 49: A system is disclosed according to Statements 46-48, wherein the optical converter is non-rugged.

Statement 50: A system is disclosed according to Statements 46-49, wherein the power supply is non-rugged.

Statement 51: A system is disclosed according to Statements 46-50, further comprising rugged index matching medium between the radiation detector and the one or more optical fibers.

Statement 52: A system is disclosed according to Statements 46-51, further comprising one or more of a lens, an optical filter, a reflector, a polarizer, and a beam expander.

Statement 53: A system is disclosed according to Statements 46-52, wherein each of the one or more optical fibers have varying diameters.

Statement 54: A system is disclosed according to Statements 46-53, wherein each of the one or more optical fibers of the bundle has a layer of cladding.

Statement 55: A system is disclosed according to Statements 46-54, wherein the one or more optical fibers of the bundle have one more layers of a temperature resistant coating material.

Statement 56: A system is disclosed according to Statements 46-55, wherein the bundle has a temperature resistant coating material.

Statement 57: A system is disclosed according to Statements 46-56, wherein the temperature resistant coating material is one of epoxy, epoxy phenolic, epoxy novolac, silicone, silicone-PFA, carbon, carbon composite, polyimide, multi-polymeric matrix, pressure-sensitive tape (PSA), acrylate, high-temperature acrylate, fluorogacrylate, silicone/acrylate, fluoropolymers, polyether ether ketone (PEEK), polybutylene terephthalate (PBT), polypropylene (PP), polyethylene (PE), polyamide (PA), low smoke zero halogen (LSZH), polyvinyl chloride (PVC), polyvinylidene fluoride (PVDF), Teflon, ceramics, aluminum cadmium, nickel aluminum bronze, nickel-plated aluminum, and anodized aluminum.

Statement 58: A system is disclosed according to Statements 46-57, wherein the scintillator is one of thallium doped sodium iodide (NaI(TI)), a lanthanum bromide (LaBr₃), thallium doped cesium iodide (CsI(TI)), sodium doped cesium iodide (CsI(Na)), and bismuth germanate (BGO).

Statement 59: A system is disclosed according to Statements 46-58, wherein the radiation detector is contained within a rugged housing.

Statement 60: A system is disclosed according to Statements 46-59, wherein one or more optical fibers is ruggedized.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A radiation sensor, comprising:
a radiation detector;
an optical converter;
a bundle of one or more optical fibers having a first end coupled with the radiation detector and a second end coupled with the optical converter;
a power supply coupled with the optical converter; and
a processor electronically coupled with the optical converter.

2. The radiation sensor as recited in claim 1, wherein the bundle of one or more optical fibers has a length of at least 300 meters.

3. The radiation sensor as recited in claim 1, wherein the optical converter is any of photo-sensor, a photomultiplier tube (PMT), a photo-diode, a photoelectric sensor, a phototransistor, a photo IC sensor, a carbon-nanotube, an organic light emitting diode (OLED), a spectrometer, a quantum dot photodetector, and a quantum photodiode.

4. The radiation sensor as recited in claim 1, wherein the radiation detector is ruggedized.

5. The radiation sensor as recited in claim 1, wherein the optical converter is non-ruggedized.

6. The radiation sensor as recited in claim 1, further comprising a ruggedized index matching medium between the radiation detector and the bundle of one or more optical fibers.

7. The radiation sensor as recited in claim 1, wherein the bundle has a temperature resistant coating material.

8. The radiation sensor as recited in claim 1, wherein the radiation detector comprises a ruggedized housing.

9. A method for downhole radiation detection, comprising:
deploying a radiation detector downhole within a wellbore;
positioning an optical converter and a power supply above ground, wherein an optical fiber cable bundle couples the radiation detector with the optical converter;
receiving luminescence from the radiation detector at the optical converter through at least the optical fiber cable; and
determining from the optical converter levels of the radiation within the wellbore.

10. The method as recited in claim 9, wherein the optical fiber cable bundle has a length of at least 300 meters.

11. The method as recited in claim 9, wherein providing the optical converter further comprises providing any of a photo-sensor, photomultiplier tube (PMT), a photo-diode, a photoelectric sensor, a phototransistor, a photo IC sensor, a carbon-nanotube, an organic light emitting diode (OLED), a spectrometer, a quantum dot photodetector, and a quantum photodiode.

12. The method as recited in claim 9, wherein the radiation detector is a ruggedized radiation detector.

13. The method as recited in claim 9, wherein the power supply is a non-ruggedized power supply.

14. The method as recited in claim 9, further comprising providing a ruggedized index matching medium between the radiation detector and the optical fiber cable bundle.

15. The method as recited in claim 9, wherein each of the one or more optical fibers of the bundle has a layer of cladding.

16. The method as recited in claim 9, wherein the radiation detector comprises a ruggedized housing.

17. A radiation sensor system, comprising:
a surface component disposed on the surface comprising:
an optical converter, and
a power supply coupled with the optical converter;
a downhole component disposed in a wellbore comprising:
a radiation detector; and
one or more optical fibers having a first end coupled with the radiation detector and a second end coupled with an optical converter.

18. The radiation sensor as recited in claim 17, wherein the one or more optical fibers has a length of at least 300 meters.

19. The radiation sensor as recited in claim 17, wherein the one or more optical fibers has a temperature resistant coating material.

20. The radiation sensor as recited in claim 17, wherein the radiation detector comprises a ruggedized housing.
